(19) United States
(12) Patent Application Publication
(10) Pub. No.: US 2012/0121299 A1
(43) Pub. Date: May 17, 2012

(54) REMOVING ELECTROPHOTOGRAPHIC CARRIER PARTICLES FROM PHOTORECEPTOR

(76) Inventor: Donald S. Rimai, Webster, NY (US)

(21) Appl. No.: 12/947,894

(22) Filed: Nov. 17, 2010

(51) Int. Cl. G03G 15/095

(52) U.S. Cl. 399/264

(57) ABSTRACT

Carrier particles are removed from a rotatable photoreceptor in an electrophotographic printer. A development member is rotated to selectively supply toner from a developer supply to the photoreceptor, the developer including toner particles and carrier particles, and at least one carrier particle from the developer is drawn into contact with the photoreceptor while the development member supplies toner to the photoreceptor. A skive is moved into proximity with the surface of the photoreceptor and energized so that it provides an electric or magnetic field when in proximity with the surface of the photoreceptor. Carrier particles on the photoreceptor are thus transported into proximity with the skive. After carrier particles are transported into proximity with the skive, the skive is retracted from the photoreceptor, so that the transported carrier particles are drawn away from the photoreceptor;

### CROSS-REFERENCE TO RELATED APPLICATIONS

Reference is made to commonly assigned, co-pending U.S. patent application Ser. No. 12/915,126, filed Oct. 29, 2010, entitled “CONTROLLING ELECTROPHOTOGRAPHIC DEVELOPER ENTERING TONING ZONE,” by Donald S. Rimai, et al, the disclosure of which is incorporated by reference herein.

### FIELD OF THE INVENTION

This invention pertains to the field of electrophotographic printing and more particularly to removing carrier particles from a photoreceptor.

### BACKGROUND OF THE INVENTION

Electrophotography is a useful process for printing images on a receiver (or “imaging substrate”), such as a piece or sheet of paper or another planar medium, glass, fabric, metal, or other objects as will be described below.

In this process, an electrostatic latent image is formed on a photoreceptor by uniformly charging the photoreceptor and then discharging selected areas of the uniform charge to yield an electrostatic charge pattern corresponding to the desired image (a “latent image”).

After the latent image is formed, charged toner particles are brought into the vicinity of the photoreceptor and are attracted to the latent image to develop the latent image into a visible image. Note that the visible image may not be visible to the naked eye depending on the composition of the toner particles (e.g. clear toner).

After the latent image is developed into a visible image on the photoreceptor, a suitable receiver is brought into juxtaposition with the visible image. A suitable electric field is applied to transfer the toner particles of the visible image to the receiver to form the desired print image on the receiver. The imaging process is typically repeated many times with reusable photoreceptors.

The receiver is then removed from its operative association with the photoreceptor and subjected to heat or pressure to permanently fix (“fuse”) the print image to the receiver. Plural print images, e.g. of separations of different colors, are overlaid on one receiver before fusing to form a multi-color print image on the receiver.

Electrophotographic (EP) printers typically transport the receiver past the photoreceptor to form the print image. The direction of travel of the receiver is referred to as the slow-scan, process, or in-track direction. This is typically the vertical (Y) direction of a portrait-oriented receiver. The direction perpendicular to the slow-scan direction is referred to as the fast-scan, cross-process, or cross-track direction, and is typically the horizontal (X) direction of a portrait-oriented receiver. “Scan” does not imply that any components are moving or scanning across the receiver; the terminology is conventional in the art.

Carrier particles can come into contact with the photoreceptor without adhering thereto; this is normal during development. Carrier particles can be drawn into contact with the photoreceptor. Such carrier particles can have numerous toner particles adhered to them when they stick to the photoreceptor. This occurrence, called developer pick-up (DPU), can cause physical damage to the photoreceptor, e.g., scratching, denting, or tearing, and can produce image artifacts by altering the electric field from that provided by the latent image in the absence of DPU. DPU commonly occurs when toner has been deposited to form the print image. The carrier particles off of which the toner particles were drawn by electrostatic attraction to the latent image therefore have an opposite-sign charge and can be electrostatically attracted to regions of the photoreceptor not having the appropriate potential to attract toner. Throughout this disclosure, by a carrier particle being “in contact with” the photoreceptor, it is meant that the carrier particle is in mechanical contact with the photoreceptor at at least one point, or is in mechanical contact with an agglomeration of toner particles, carrier particles, or contaminants that is itself in mechanical contact with the photoreceptor, in such a way that the carrier particle travels with the photoreceptor, and can travel out of the toning zone.

There is a need, therefore, for an inexpensive, efficient way of removing carrier particles from the photoreceptor.

### SUMMARY OF THE INVENTION

According to the present invention, there is provided a method of removing carrier particles from a rotatable photoreceptor in an electrophotographic printer, the photoreceptor arranged to apply toner corresponding to an image on a moving receiver, comprising:

rotating a development member to selectively supply toner from a developer supply to the photoreceptor, the developer including toner particles and carrier particles, wherein at least one carrier particle from the developer is drawn into contact with the photoreceptor while the development member supplies toner to the photoreceptor;

moving a skive into proximity with the surface of the photoreceptor;

energizing the skive so that it provides an electric or magnetic field when in proximity with the surface of the photoreceptor, so that carrier particles on the photoreceptor are transported into proximity with the skive; and

after carrier particles are transported into proximity with the skive, retracting the skive from the photoreceptor, so that the transported carrier particles are drawn away from the photoreceptor;

An advantage of this invention is that it uses mechanical forces to help remove carrier particles in addition to using electrical or magnetic forces. Various embodiments remove carrier particles with reduced risk of those particles' scratching the photoreceptor. Strong electrostatic forces can be used by way of the energized skive to remove DPU from the photoreceptor without disturbing the latent image. Carrier particles can be cleaned off the skive at a distance from the photoreceptor, advantageously reducing the probability that cleaned-off carrier particles will be attracted to, and re-deposited on, the photoreceptor. In various embodiments, the photoreceptor is irradiated so that carrier particles can more readily be removed; the skive serves as a light shield to reduce the chance of damage to the latent image while DPU is being removed.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is an elevational cross-section of an electrophotographic reproduction apparatus according to an embodiment;

FIG. 2 is an elevational cross-section of the reprographic image-producing portion of the apparatus of FIG. 1; and

FIG. 3 is a flowchart of a method of removing carrier particles from a rotatable photoreceptor according to an embodiment.

The attached drawings are for purposes of illustration and are not necessarily to scale.

### DETAILED DESCRIPTION OF THE INVENTION

As used herein, “toner particles” are particles of one or more material(s) that are transferred by an EP printer to a receiver to produce a desired effect or structure (e.g. a print image, texture, pattern, or coating) on the receiver. Toner particles can be ground from larger solids, or chemically prepared (e.g. precipitated from a solution of a pigment and a dispersant using an organic solvent), as is known in the art. Toner particles can have a range of diameters, e.g. less than 8 μm, on the order of 10-15 μm, up to approximately 30 μm, or larger (“diameter” refers to the volume-weighted median diameter, as determined by a device such as a Coulter Multisizer).

“Toner” refers to a material or mixture that contains toner particles, and that can form an image, pattern, or coating when deposited on an imaging member including a photoreceptor, a photoconductor, or an electrostatically-charged or magnetic surface. Toner can be transferred from the imaging member to a receiver. Toner is also referred to in the art as marking particles, dry ink, or developer, but note that herein “developer” is used differently, as described below. Toner can be a dry mixture of particles or a suspension of particles in a liquid toner base.

Toner includes toner particles and can include other particles. Any of the particles in toner can be of various types and have various properties. Such properties can include absorption of incident electromagnetic radiation (e.g. particles containing colorants such as dyes or pigments), absorption of moisture or gasses (e.g. desiccants or getters), suppression of bacterial growth (e.g. biocides, particularly useful in liquid-toner systems), adhesion to the receiver (e.g. binders), electrical conductivity or low magnetic reluctance (e.g. metal particles), electrical resistivity, texture, gloss, magnetic remnance, florescence, resistance to etchants, and other properties of additives known in the art.

In single-component or monocomponent development systems, “developer” refers to toner alone. In these systems, none, some, or all of the particles in the toner can themselves be magnetic. However, developer in a monocomponent system does not include magnetic carrier particles. In dual-component, two-component, or multi-component development systems, “developer” refers to a mixture including toner particles and magnetic carrier particles, which can be electrically-conductive or -non-conductive. Toner particles can be magnetic or non-magnetic. The carrier particles can be larger than the toner particles, e.g. 15-20 μm or 20-300 μm in diameter. A magnetic field is used to move the developer in these systems by exerting a force on the magnetic carrier particles. The developer is moved into proximity with an imaging member or transfer member by the magnetic field, and the toner or toner particles in the developer are transferred from the developer to the member by an electric field, as will be described further below. The magnetic carrier particles are not intentionally deposited on the member by action of the electric field; only the toner is intentionally deposited. However, magnetic carrier particles, and other particles in the toner or developer, can be unintentionally transferred to an imaging member. Developer can include other additives known in the art, such as those listed above for toner. Toner and carrier particles can be substantially spherical or non-spherical.

The electrophotographic process can be embodied in devices including printers, copiers, scanners, and facsimiles, and analog or digital devices, all of which are referred to herein as “printers.” Various embodiments are useful with electrostatographic printers such as electrophotographic printers that employ toner developed on an electrophotographic receiver, and ionographic printers and copiers that do not rely upon an electrophotographic receiver. Electrophotography and ionography are types of electrostatography (printing using electrostatic fields), which is a subset of electrography (printing using electric fields).

A digital reproduction printing system (“printer”) typically includes a digital front-end processor (DFE), a print engine (also referred to in the art as a “marking engine”) for applying toner to the receiver, and one or more post-printing finishing system(s) (e.g. a UV coating system, a glosser system, or a laminator system). A printer can reproduce pleasing black-and-white or color onto a receiver. A printer can also produce selected patterns of toner on a receiver, which patterns (e.g. surface textures) do not correspond directly to a visible image. The DFE receives input electronic files (such as Postscript command files) composed of images from other input devices (e.g., a scanner, a digital camera). The DFE can include various function processors, e.g. a raster image processor (RIP), image positioning processor, image manipulation processor, color processor, or image storage processor. The DFE rasterizes input electronic files into image bitmaps for the print engine to print. In some embodiments, the DFE permits a human operator to set up parameters such as layout, font, color, paper type, or post-finishing options. The print engine takes the rasterized image bitmap from the DFE and renders the bitmap into a form that can control the printing process from the exposure device to transferring the print image onto the receiver. The finishing system applies features such as protection, glossing, or binding to the prints. The finishing system can be implemented as an integral component of a printer, or as a separate machine through which prints are fed after they are printed.

The printer can also include a color management system which captures the characteristics of the image printing process implemented in the print engine (e.g. the electrophotographic process) to provide known, consistent color reproduction characteristics. The color management system can also provide known color reproduction for different inputs (e.g. digital camera images or film images).

In an embodiment of an electrophotographic modular printing machine useful with the present invention, e.g. the NEXPRESS 2100 printer manufactured by Eastman Kodak Company of Rochester, N.Y., color-toner print images are made in a plurality of color imaging modules arranged in tandem, and the print images are successively electrostatically transferred to a receiver adhered to a transport web moving through the modules. Colored toners include colorants, e.g. dyes or pigments, which absorb specific wavelengths of visible light. Commercial machines of this type typically employ intermediate transfer members in the respective modules for transferring visible images from the photoreceptor and transferring print images to the receiver. In other electrophotographic printers, each visible image is directly transferred to a receiver to form the corresponding print image.

Electrophotographic printers having the capability to also deposit clear toner using an additional imaging module are also known. The provision of a clear-toner overcoat to a color print is desirable for providing protection of the print from fingerprints and reducing certain visual artifacts. Clear toner uses particles that are similar to the toner particles of the color development stations but without colored material (e.g. dye or pigment) incorporated into the toner particles. However, a clear-toner overcoat can add cost and reduce color gamut of the print; thus, it is desirable to provide for operator/user selection to determine whether or not a clear-toner overcoat will be applied to the entire print. A uniform layer of clear toner can be provided. A layer that varies inversely according to heights of the toner stacks can also be used to establish level toner stack heights. The respective color toners are deposited one upon the other at respective locations on the receiver and the height of a respective color toner stack is the sum of the toner heights of each respective color. Uniform stack height provides the print with a more even or uniform gloss.

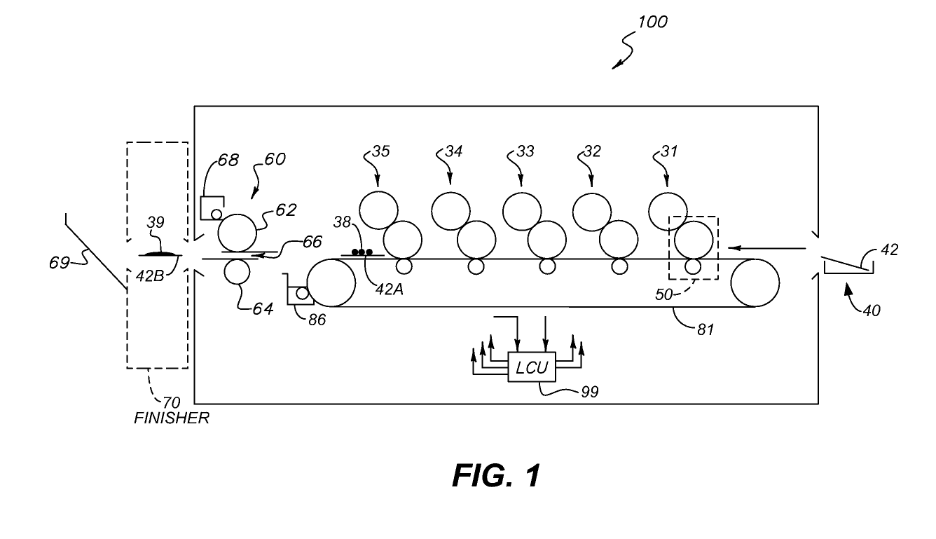

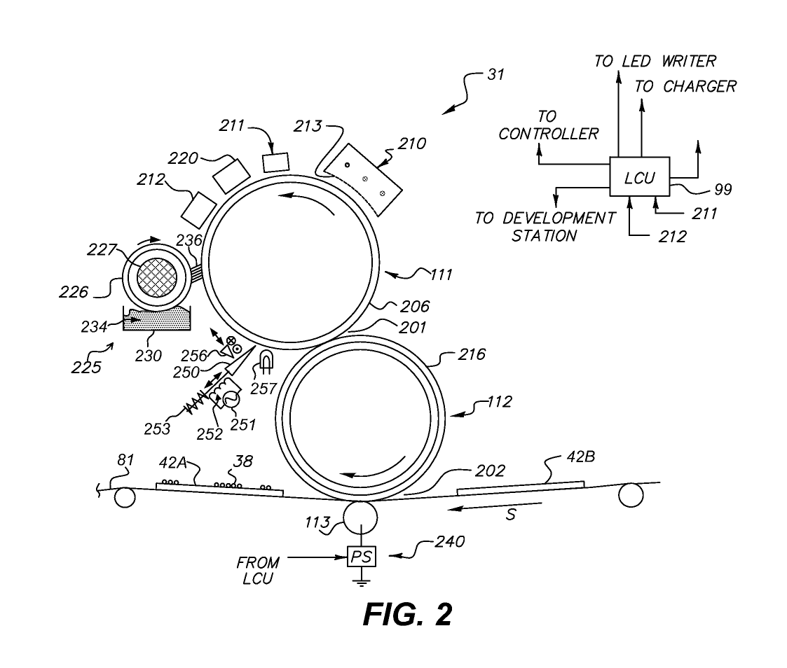

FIGS. 1 and 2 are elevational cross-sections showing portions of a typical electrophotographic printer 100 useful with the present invention. Printer 100 is adapted to produce images, such as single-color (monochrome), CMYK, or pentachrome (five-color) images, on a receiver (multicolor images are also known as “multi-component” images). Images can include text, graphics, photos, and other types of visual content. One embodiment involves printing using an electrophotographic print engine having five sets of single-color image-producing or -printing stations or modules arranged in tandem, but more or less than five colors can be combined on a single receiver. Other electrophotographic writers or printer apparatus can also be included. Various components of printer 100 are shown as rollers; other configurations are also possible, including belts.

Referring to FIG. 1, printer 100 is an electrophotographic printing apparatus having a number of tandemly-arranged electrophotographic image-forming printing modules 31, 32, 33, 34, 35, also known as electrophotographic imaging subsystems. Each printing module produces a single-color toner image for transfer using a respective transfer subsystem 50 (for clarity, only one is labeled) to a receiver 42 successively moved through the modules. Receiver 42 is transported from supply unit 40, which can include active feeding subsystems as known in the art, into printer 100. In various embodiments, the visible image can be transferred directly from an imaging roller to a receiver, or from an imaging roller to one or more transfer roller(s) or belt(s) in sequence in transfer subsystem 50, and thence to receiver 42. Receiver 42 is, for example, a selected section of a web of, or a cut sheet of, planar media such as paper or transparency film.

Each receiver, during a single pass through the five modules, can have transferred in registration thereto up to five single-color toner images to form a pentachrome image. As used herein, the term “pentachrome” implies that in a print image, combinations of various of the five colors are combined to form other colors on the receiver at various locations on the receiver, and that all five colors participate to form process colors in at least some of the subsets. That is, each of the five colors of toner can be combined with toner of one or more of the other colors at a particular location on the receiver to form a color different than the colors of the toners combined at that location. In an embodiment, printing module 31 forms black (K) print images, 32 forms yellow (Y) print images, 33 forms magenta (M) print images, and 34 forms cyan (C) print images.

Printing module 35 can form a red, blue, green, or other fifth print image, including an image formed from a clear toner (i.e. one lacking pigment). The four subtractive primary colors, cyan, magenta, yellow, and black, can be combined in various combinations of subsets thereof to form a representative spectrum of colors. The color gamut or range of a printer is dependent upon the materials used and process used for forming the colors. The fifth color can therefore be added to improve the color gamut. In addition to adding to the color gamut, the fifth color can also be a specialty color toner or spot color, such as for making proprietary logos or colors that cannot be produced with only CMYK colors (e.g. metallic, fluorescent, or pearlescent colors), or a clear toner or tinted toner. Tinted toners absorb less light than they transmit, but do contain pigments or dyes that move the hue of light passing through them towards the hue of the tint. For example, a blue-tinted toner coated on white paper will cause the white paper to appear light blue when viewed under white light, and will cause yellows printed under the blue-tinted toner to appear slightly greenish under white light.

Receiver 42A is shown after passing through printing module 35. Print image 38 on receiver 42A includes unfused toner particles.

Subsequent to transfer of the respective print images, overlaid in registration, one from each of the respective printing modules 31, 32, 33, 34, 35, receiver 42A is advanced to a fuser 60, i.e. a fusing or fixing assembly, to fuse print image 38 to receiver 42A. Transport web 81 transports the print-image-carrying receivers to fuser 60, which fixes the toner particles to the respective receivers by the application of heat and pressure. The receivers are serially de-tacked from transport web 81 to permit them to feed cleanly into fuser 60. Transport web 81 is then reconditioned for reuse at cleaning station 86 by cleaning and neutralizing the charges on the opposed surfaces of the transport web 81. A mechanical cleaning station (not shown) for scraping or vacuuming toner off transport web 81 can also be used independently or with cleaning station 86. The mechanical cleaning station can be disposed along transport web 81 before or after cleaning station 86 in the direction of rotation of transport web 81.

Fuser 60 includes a heated fusing roller 62 and an opposing pressure roller 64 that form a fusing nip 66 therebetween. In an embodiment, fuser 60 also includes a release fluid application substation 68 that applies release fluid, e.g. silicone oil, to fusing roller 62. Alternatively, wax-containing toner can be used without applying release fluid to fusing roller 62. Other embodiments of fusers, both contact and non-contact, can be employed with the present invention. For example, solvent fixing uses solvents to soften the toner particles so they bond with the receiver. Photoflash fusing uses short bursts of high-frequency electromagnetic radiation (e.g. ultraviolet light) to melt the toner. Radiant fixing uses lower-frequency electromagnetic radiation (e.g. infrared light) to more slowly melt the toner. Microwave fixing uses electromagnetic radiation in the microwave range to heat the receivers (primarily), thereby causing the toner particles to melt by heat conduction, so that the toner is fixed to the receiver.

The receivers (e.g. receiver 42B) carrying the fused image (e.g., fused image 39) are transported in a series from the fuser 60 along a path either to a remote output tray 69, or back to printing modules 31, 32, 33, 34, 35 to create an image on the backside of the receiver, i.e. to form a duplex print. Receivers can also be transported to any suitable output accessory. For example, an auxiliary fuser or glossing assembly can provide a clear-toner overcoat. Printer 100 can also include multiple fusers 60 to support applications such as overprinting, as known in the art.

In various embodiments, between fuser 60 and output tray 69, receiver 42B passes through finisher 70. Finisher 70 performs various paper-handling operations, such as folding, stapling, saddle-stitching, collating, and binding.

Printer 100 includes main printer apparatus logic and control unit (LCU) 99, which receives input signals from the various sensors associated with printer 100 and sends control signals to the components of printer 100. LCU 99 can include a microprocessor incorporating suitable look-up tables and control software executable by the LCU 99. It can also include a field-programmable gate array (FPGA), programmable logic device (PLD), microcontroller, or other digital control system. LCU 99 can include memory for storing control software and data. Sensors associated with the fusing assembly provide appropriate signals to the LCU 99. In response to the sensors, the LCU 99 issues command and control signals that adjust the heat or pressure within fusing nip 66 and other operating parameters of fuser 60 for receivers. This permits printer 100 to print on receivers of various thicknesses and surface finishes, such as glossy or matte.

Image data for writing by printer 100 can be processed by a raster image processor (RIP; not shown), which can include a color separation screen generator or generators. The output of the RIP can be stored in frame or line buffers for transmission of the color separation print data to each of respective LED writers, e.g. for black (K), yellow (Y), magenta (M), cyan (C), and red (R), respectively. The RIP or color separation screen generator can be a part of printer 100 or remote therefrom. Image data processed by the RIP can be obtained from a color document scanner or a digital camera or produced by a computer or from a memory or network which typically includes image data representing a continuous image that needs to be reprocessed into halftone image data in order to be adequately represented by the printer. The RIP can perform image processing processes, e.g. color correction, in order to obtain the desired color print. Color image data is separated into the respective colors and converted by the RIP to halftone dot image data in the respective color using matrices, which comprise desired screen angles (measured counterclockwise from rightward, the +X direction) and screen rulings. The RIP can be a suitably-programmed computer or logic device and is adapted to employ stored or computed matrices and templates for processing separated color image data into rendered image data in the form of halftone information suitable for printing. These matrices can include a screen pattern memory (SPM).

Further details regarding printer 100 are provided in U.S. Pat. No. 6,608,641, issued on Aug. 19, 2003, to Peter S. Alexandrovich et al., and in U.S. Publication No. 2006/0133870, published on Jun. 22, 2006, by Yee S. Ng et al., the disclosures of which are incorporated herein by reference.

FIG. 2 shows more details of printing module 31, which is representative of printing modules 32, 33, 34, and 35 (FIG. 1). Primary charging subsystem 210 uniformly electrostatically charges photoreceptor 206 of imaging member 111, shown in the form of an imaging cylinder. Charging subsystem 210 includes a grid 213 having a selected voltage. Additional necessary components provided for control can be assembled about the various process elements of the respective printing modules. Meter 211 measures the uniform electrostatic charge provided by charging subsystem 210, and meter 212 measures the post-exposure surface potential within a patch area of a latent image formed from time to time in a non-image area on photoreceptor 206. Other meters and components can be included.

LCU 99 sends control signals to the charging subsystem 210, the exposure subsystem 220 (e.g., laser or LED writers), and the respective development station 225 of each printing module 31, 32, 33, 34, 35 (FIG. 1), among other components. Each printing module can also have its own respective controller (not shown) coupled to LCU 99.

Imaging member 111 includes photoreceptor 206. Photoreceptor 206 includes a photoconductive layer formed on an electrically conductive substrate. The photoconductive layer is an insulator in the substantial absence of light so that electric charges are retained on its surface. Upon exposure to light, the charge is dissipated. In various embodiments, photoreceptor 206 is part of, or disposed over, the surface of imaging member 111, which can be a plate, drum, or belt. Photoreceptors can include a homogeneous layer of a single material such as vitreous selenium or a composite layer containing a photoconductor and another material. Photoreceptors can also contain multiple layers.

An exposure subsystem 220 is provided for image-wise modulating the uniform electrostatic charge on photoreceptor 206 by exposing photoreceptor 206 to electromagnetic radiation to form a latent electrostatic image (e.g., of a separation corresponding to the color of toner deposited at this printing module). The uniformly-charged photoreceptor 206 is typically exposed to actinic radiation provided by selectively activating particular light sources in an LED array or a laser device outputting light directed at photoreceptor 206. In embodiments using laser devices, a rotating polygon (not shown) is used to scan one or more laser beam(s) across the photoreceptor in the fast-scan direction. One dot site is exposed at a time, and the intensity or duty cycle of the laser beam is varied at each dot site. In embodiments using an LED array, the array can include a plurality of LEDs arranged next to each other in a line, all dot sites in one row of dot sites on the photoreceptor can be selectively exposed simultaneously, and the intensity or duty cycle of each LED can be varied within a line exposure time to expose each dot site in the row during that line exposure time.

As used herein, an “engine pixel” is the smallest addressable unit on photoreceptor 206 or receiver 42 (FIG. 1) which the light source (e.g., laser or LED) can expose with a selected exposure different from the exposure of another engine pixel. Engine pixels can overlap, e.g., to increase addressability in the slow-scan direction (S). Each engine pixel has a corresponding engine pixel location, and the exposure applied to the engine pixel location is described by an engine pixel level.

The exposure subsystem 220 can be a write-white or write-black system. In a write-white or charged-area-development (CAD) system, the exposure dissipates charge on areas of photoreceptor 206 to which toner should not adhere. Toner particles are charged to be attracted to the charge remaining on photoreceptor 206. The exposed areas therefore correspond to white areas of a printed page. In a write-black or discharged-area development (DAD) system, the toner is charged to be attracted to a bias voltage applied to photoreceptor 206 and repelled from the charge on photoreceptor 206. Therefore, toner adheres to areas where the charge on photoreceptor 206 has been dissipated by exposure. The exposed areas therefore correspond to black areas of a printed page.

A development station 225 includes toning shell 226, which can be rotating or stationary, for applying toner of a selected color to the latent image on photoreceptor 206 to produce a visible image on photoreceptor 206. Development station 225 is electrically biased by a suitable respective voltage to develop the respective latent image, which voltage can be supplied by a power supply (not shown). Developer is provided to toning shell 226 by a supply system (not shown), e.g., a supply roller, auger, or belt. Toner is transferred by electrostatic forces from development station 225 to photoreceptor 206. These forces can include Coulombic forces between charged toner particles and the charged electrostatic latent image, and Lorentz forces on the charged toner particles due to the electric field produced by the bias voltages.

In an embodiment, development station 225 employs a two-component developer that includes toner particles and magnetic carrier particles. Development station 225 includes a magnetic core 227 to cause the magnetic carrier particles near toning shell 226 to form a “magnetic brush,” as known in the electrophotographic art. Magnetic core 227 can be stationary or rotating, and can rotate with a speed and direction the same as or different than the speed and direction of toning shell 226. Magnetic core 227 can be cylindrical or non-cylindrical, and can include a single magnet or a plurality of magnets or magnetic poles disposed around the circumference of magnetic core 227. Alternatively, magnetic core 227 can include an array of solenoids driven to provide a magnetic field of alternating direction. Magnetic core 227 preferably provides a magnetic field of varying magnitude and direction around the outer circumference of toning shell 226. Further details of magnetic core 227 can be found in U.S. Pat. No. 7,120,379 to Eck et al., issued Oct. 10, 2006, and in U.S. Publication No. 2002/0168200 to Stelter et al., published Nov. 14, 2002, the disclosures of which are incorporated herein by reference. Development station 225 can also employ a mono-component developer comprising toner, either magnetic or non-magnetic, without separate magnetic carrier particles.

As used herein, the term “development member” refers to the member(s) or subsystem(s) that provide toner to photoreceptor 206. In an embodiment, toning shell 226 is a development member. In another embodiment, toning shell 226 and magnetic core 227 together compose a development member.

Transfer subsystem 50 (FIG. 1) includes transfer backup member 113, and intermediate transfer member 112 for transferring the respective print image from photoreceptor 206 of imaging member 111 through a first transfer nip 201 to surface 216 of intermediate transfer member 112, and thence to a receiver (e.g., 42B) which receives the respective toned print images 38 from each printing module in superposition to form a composite image thereon. Print image 38 is e.g., a separation of one color, such as cyan. Receivers are transported by transport web 81. Transfer to a receiver is effected by an electrical field provided to transfer backup member 113 by power source 240, which is controlled by LCU 99. Receivers can be any objects or surfaces onto which toner can be transferred from imaging member 111 by application of the electric field. In this example, receiver 42B is shown prior to entry into second transfer nip 202, and receiver 42A is shown subsequent to transfer of the print image 38 onto receiver 42A.

Still referring to FIG. 2, toner is transferred from toning shell 226 to photoreceptor 206 in toning zone 236. As described above, toner is selectively supplied to the photoreceptor by toning shell 226. Toning shell 226 receives developer 234 from developer supply 230, which can include a mixer. Developer 234 includes toner particles and carrier particles.

Skive 250 is arranged in proximity with the surface of photoreceptor 206 to clean DPU off photoreceptor 206. Skive 250 can be moved closer to or farther from the surface of photoreceptor 206, e.g., using electromagnetic actuator 252 (represented graphically in FIG. 2 as a coil). Electromagnetic actuator 252 can be a solenoid, motor (servo or stepper), electromagnetically-operated linkage, or other electrical or electromechanical device for converting electrical current to mechanical motion of skive 250. Further examples of electromagnetic actuators include solenoids, motors driving rack-and-pinion arrangements, motors driving cams, motors driving linear slides, and electrically-driven compressors driving pistons. Non-electromagnetic (e.g., pneumatic or hydraulic) actuators can also be used.

In an embodiment, current is supplied by power source 251 (shown in FIG. 2 as an AC voltage supply).

In an embodiment, spring 253 produces a force on skive 250 opposite the motive force provided by electromagnetic actuator 252. In another embodiment, electromagnetic actuator 252 drives skive 250 in both directions.

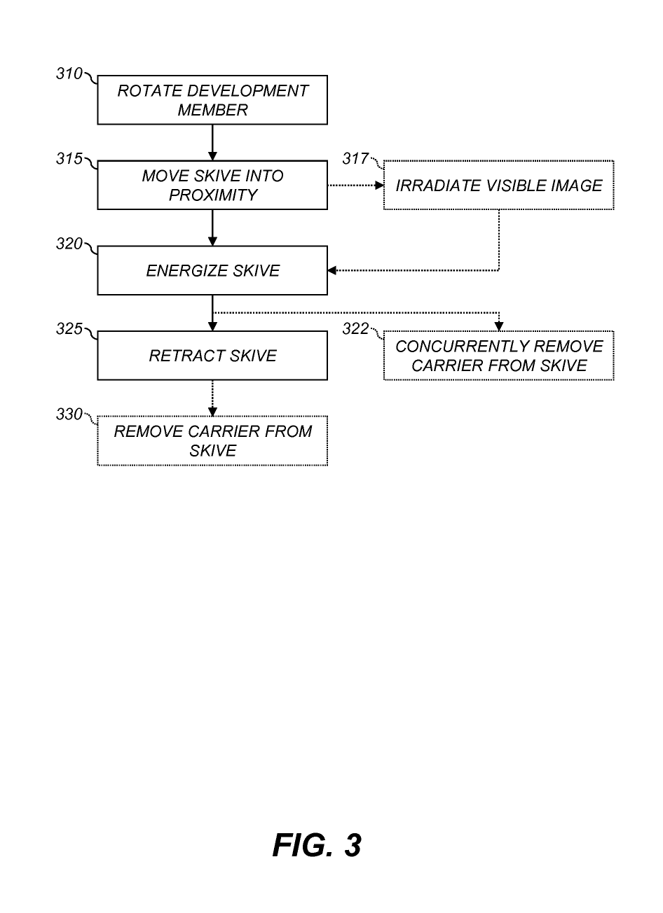

FIG. 3 is a flowchart of a method of removing carrier particles from a rotatable photoreceptor according to an embodiment. In the following discussion, part numbers given in parentheses refer to the exemplary embodiment shown in FIG. 2; these references are representative only, and are not limiting. The photoreceptor (206) is arranged to apply toner corresponding to an image on a moving receiver (42A). Processing begins with step 310.

In step 310, a development member (e.g., toning shell 226) is rotated to selectively supply toner from a developer supply (234) to the photoreceptor. The developer includes toner particles and carrier particles, as discussed above. While the development member is supplying toner to the photoreceptor, at least one carrier particle from the developer is drawn into contact with the photoreceptor. Step 310 is followed by step 315.

In step 315, a skive (e.g., skive 250 of FIG. 2) is moved into proximity with the surface of the photoreceptor. The skive can be moved so that at least one point on the skive is in mechanical contact with at least one point on the surface of the photoreceptor. This can provide a scraping action to clean the photoreceptor of even very small particles. The skive can also be moved so that the distance between the skive and the photoreceptor, referred to herein as the “skive gap” (i.e., the shortest distance between any point on the skive and any other point on the photoreceptor, or the separation at the point of closest approach between the two), is less than or equal to the mean diameter of carrier particles. This permits the skive to remove carrier particles without removing smaller toner particles in contact with the photoreceptor. The skive gap can also be greater than the mean diameter of the carrier particles to remove carrier particles and provide increased robustness against vibration. Increasing the skive gap can reduce the amount of DPU collected by the skive, but also reduces the probability that carrier particles will be dragged or pushed by the skive across the photoreceptor, possibly damaging the photoreceptor. Step 315 is followed by step 320 and optional step 317 (discussed further below).

In step 320, the skive is energized so that it provides an electric or magnetic field when in proximity with the surface of the photoreceptor. This causes one or more carrier particles on the photoreceptor to be transported into proximity with the skive. That is, the carrier particles are moved into mechanical contact with the skive at one or more points, or are moved so that they are attracted to the skive but spaced apart from it by intervening matter, e.g., glommed-on or scummed toner adhered to the carrier particles, or other toner or carrier particles. Carrier particles are drawn away from the photoreceptor to the skive and carried with the skive, rather than being carried with the photoreceptor. Step 320 is followed by step 325 and optional step 322.

In step 325, the skive is retracted from the photoreceptor after carrier particles are transported into proximity with the skive. The transported carrier particles therefore are drawn away from the photoreceptor. Step 325 is followed by optional step 330.

In optional step 322, the transported carrier particles are removed from the skive while retracting the skive. In optional step 330, the transported carrier particles are removed from the skive after retracting the skive (i.e., after the skive has finished moving away from the photoreceptor).

In various embodiments, the transported carrier particles are removed from the skive by de-energizing the skive so that the electric or magnetic field no longer holds the carrier particles to the skive. A waste tray or other waste system can be provided to catch carrier particles that fall off the skive. The carrier particles can be returned to the developer supply or discarded.

In various embodiments, the removed carrier particles are returned to the developer supply. This advantageously reduces waste of carrier particles.

In various embodiments, the transported carrier particles are removed by wiping a cleaning blade 256 (FIG. 2) across the surface of the skive while it retracts. The cleaning blade can be movable or fixed in position. A fixed cleaning blade can be set at an angle to the skive, so that as the skive retracts past the cleaning blade, DPU (or whatever combination of carrier particles, toner particles, and contaminants is present on the skive) is pushed to the end. A movable cleaning blade can be pushed across the skive while the skive retracts, or after the skive retracts.

In various embodiments, an electrostatic latent image is formed on the surface of the photoreceptor. Toner is applied to the electrostatic latent image to develop it into a visible image while rotating the development member. In these embodiments, optional step 317 is employed, and is followed by step 320.

Specifically, in these embodiments, the method further includes irradiating the visible image (step 317) after moving the skive into proximity with the surface of the photoreceptor. Residual charge on the photoreceptor is removed. The removed charge can be localized charges, or a uniform or average charge across the photoreceptor or a substantial portion thereof. Even though the electrostatic forces which drew the toner particles to the latent image during development can be removed by this step, van der Waal's forces can keep the toner particles of the print image on the photoreceptor. Removing charges can advantageously reduce the attraction of carrier particles to the photoreceptor, increasing the effect on those particles of the energized skive.

The visible image can be irradiated with lamp 257 (FIG. 2). Carrier particles passing through the skive gap are brought under the lamp, and the photoreceptor under or around them is irradiated. Those carrier particles are then attracted to the trailing side of the skive, viewed in the direction of rotation of the photoreceptor.

In various embodiments, the skive is positioned to substantially prevent the radiation from irradiating the latent image in toning zone 236 (FIG. 2). This advantageously reduces degradation of image quality due to irradiation of the latent image before it is developed into a visible image.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. The word “or” is used in this disclosure in a non-exclusive sense, unless otherwise explicitly noted.

The invention has been described in detail with particular reference to certain preferred embodiments thereof, but it will be understood that variations, combinations, and modifications can be effected by a person of ordinary skill in the art within the spirit and scope of the invention.

### PARTS LIST

31, 32, 33, 34, 35 printing module
38 print image
39 fused image
40 supply unit
42, 42A, 42B receiver
50 transfer subsystem
60 fuser
62 fusing roller
64 pressure roller
66 fusing nip
68 release fluid application substation
69 output tray
70 finisher
81 transport web
86 cleaning station
99 logic and control unit (LCU)
100 printer
111 imaging member
112 transfer member
113 transfer backup member
124, 125 corona tack-down chargers
201 transfer nip
202 second transfer nip
206 photoreceptor
210 charging subsystem
211 meter
212 meter
213 grid
216 surface
220 exposure subsystem
225 development station
226 toning shell
227 magnetic core
230 developer supply
234 developer
236 toning zone
240 power source
250 skive
251 power source
252 electromagnetic actuator
253 spring
256 cleaning blade
257 lamp
310 rotate development member step
315 move skive into proximity step
317 irradiate visible image step
320 energize skive step
322 concurrently remove carrier from skive step
325 retract skive step
330 remove carrier from skive step

1. A method of removing carrier particles from a rotatable photoreceptor in an electrophotographic printer, the photoreceptor arranged to apply toner corresponding to an image on a moving receiver, comprising:
rotating a development member to selectively supply toner from a developer supply to the photoreceptor, the developer including toner particles and carrier particles, wherein at least one carrier particle from the developer is drawn into contact with the photoreceptor while the development member supplies toner to the photoreceptor;
moving a skive into proximity with the surface of the photoreceptor;
energizing the skive so that it provides an electric or magnetic field when in proximity with the surface of the photoreceptor, so that carrier particles on the photoreceptor are transported into proximity with the skive; and
after carrier particles are transported into proximity with the skive, retracting the skive from the photoreceptor, so that the transported carrier particles are drawn away from the photoreceptor;

2. The method according to claim 1, further including removing the transported carrier particles from the skive after retracting the skive.

3. The method according to claim 2, wherein the removed carrier particles are returned to the developer supply.

4. The method according to claim 1, further including removing the transported carrier particles from the skive while retracting the skive.

5. The method according to claim 1, wherein the transported carrier particles are removed by wiping a cleaning blade across the surface of the skive while it retracts.

6. The method according to claim 1, further including forming an electrostatic latent image on the surface of the photoreceptor, and applying toner to the electrostatic latent image to develop it into a visible image, while rotating the development member;
further including irradiating the visible image after moving the skive into proximity with the surface of the photoreceptor, so that residual charge on the photoreceptor is removed.

7. The method according to claim 6, wherein toner is supplied from the developer supply to the photoreceptor in a toning zone, further including positioning the skive to substantially prevent the radiation from irradiating the latent image in the toning zone.

8. The method according to claim 1, wherein the moving-into-proximity step includes applying a motive force to the skive for moving the skive using an electromagnetic actuator.

9. The method according to claim 8, further including providing a spring that produces a force on the skive opposite to the motive force.
